(19) United States
(12) Patent Application Publication
(10) Pub. No.: US 2014/0373363 A1
(43) Pub. Date: Dec. 25, 2014

(54) Utility Knife

(71) Applicant: Harry S. Billado, JR., Newbury, NH (US)

(72) Inventor: Harry S. Billado, JR., Newbury, NH (US)

(21) Appl. No.: 14/211,956

(22) Filed: Mar. 14, 2014

Related U.S. Application Data
(60) Provisional application No. 61/801,095, filed on Mar. 15, 2013.

(51) Int. Cl. B26B 5/00; B26B 1/08

(52) U.S. Cl. CPC B26B 5/003; B26B 1/08
USPC 30/152; 30/335

(57) ABSTRACT

A utility knife including a housing and a blade carrier at least partially within the housing. The blade carrier is configured to receive a first blade in a first end of the blade carrier and a second blade in a second end of the blade carrier, and is movable within the housing between a first extended position, a retracted position, and a second extended position. When the blade carrier is in the first extended position, the first blade is extended outwardly from a first end of the housing, when the blade carrier is in the retracted position the first and second blades are disposed entirely within the housing, and when the blade carrier is in the second extended position, the second blade is extended outwardly from the second end of the housing.

### CROSS REFERENCE TO RELATED APPLICATIONS

The present application claims the benefit of the filing date of U.S. Provisional Application Ser. No. 61/801,095, filed, Mar. 15, 2013, the entire teachings of which are hereby incorporated herein by reference.

### TECHNICAL FIELD

The present disclosure relates to knives, and, more particularly, to a utility knife having two retractable blades.

### BACKGROUND

Utility knives are used in a variety of applications, such as carpentry, floor covering installations, hobby work, mechanical work, electrical work, etc. Currently, there are a variety of utility knives available. One common type of utility knife is of relatively simple construction, having a hollow handle serving as a housing for an internally housed retractable blade or a fixed blade that remains with cutting edge exposed. In most utility knives, the blade mounted for use is either immovably fixed, or is retractable into or extendable out of the handle. When the blade is constantly exposed, consequent risks of injury to people or objects nearby are possible while the knife is not in use. However, such risk of injury is prevented when the retractable blade is manually retracted into the handle.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a side view of one embodiment of a retractable utility knife showing a blade carrier separated from a utility knife housing consistent with the present disclosure;

FIG. 2 is a side view of the knife of FIG. 1 fully assembled, including the blade carried positioned within the knife housing; and

FIGS. 3A-3C are side views of the knife of FIG. 2 showing the first utility blade moving from a retracted position to an extended position and back to the retracted position and the second utility blade moving from a retracted position to an extended position consistent with the present disclosure.

### DETAILED DESCRIPTION

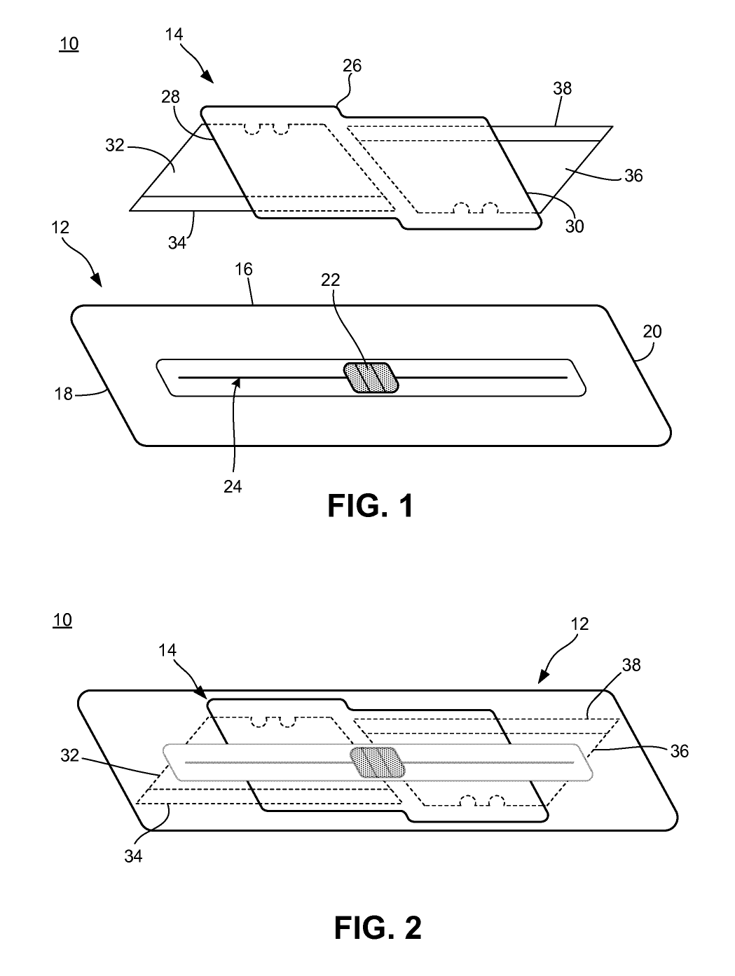

FIG. 1 is a side view of one embodiment of a retractable utility knife 10 consistent with the present disclosure. As shown, the utility knife 10 generally includes a housing 12 and a blade carrier 14 to be positioned within the housing 12. FIG. 1 illustrates the housing 12 and blade carrier 14 being separated from one another for ease of description. FIG. 2 illustrates a side view of the knife 10 of FIG. 1 fully assembled.

As shown, the housing 12 includes a body 16 having a first end 18 and an opposing second end 20. As generally understood, the body 16 may be configured to house and retain the blade carrier 14. For example, the body 16 may include a cavity (not shown) shaped and/or sized to receive and house the blade carrier 14. The housing 12 further includes a means of moving the blade carrier 14 in a variety of positions along a length of the housing 12. For example, the housing 12 may include an actuator element 22 (e.g. a button) configured to receive user input and slide along a track 24 to which the actuator element 22 is coupled. Furthermore, the actuator element 22 is coupled to a portion of the blade carrier 14 when the blade carrier 14 is positioned within the housing 14, such that the blade carrier 14 moves in relation to movement of the actuator element 22.

In the illustrated embodiment, the blade carrier 14 includes a body 26 having a first end 28 and an opposing second end 30, wherein each end is configured to retain first and second blades 32, 36, respectively. The blades 32, 36 may be any known cutting blade or other implement, such marking implement, for utility knives. Although, in the illustrated embodiment the blades 32,36 are shown as having the same shape, the blades 32,36 may have different shapes, e.g. for performing different functions. Also, the blades may have different constructions. For example, one of the blades 32, 36 may be a cutting blade having a cutting edge and another of the blades 32, 36 may be a marking blade, e.g. made from a marking material and having one or more marking edges for marking a work surface.

As generally understood, the first and second ends 28, 30 may include any known means of retaining the first and second blades 32, 36, such as, for example, slots shaped and/or sized to receive and retain the blades, a spring biased mechanism to retain the blades, etc. As shown in FIG. 2, the blade carrier 14, including the blades 32, 36 may fit entirely within the housing 18 and, when the actuator element 22 of the housing 18 is in a retracted position (e.g. safety position), the blade carrier 14, including both blades 32, 36 are entirely housed and contained within, such that the edges 34, 38 of the first and second blades 32, 36, respectively, are not exposed, thereby preventing accidental cutting.

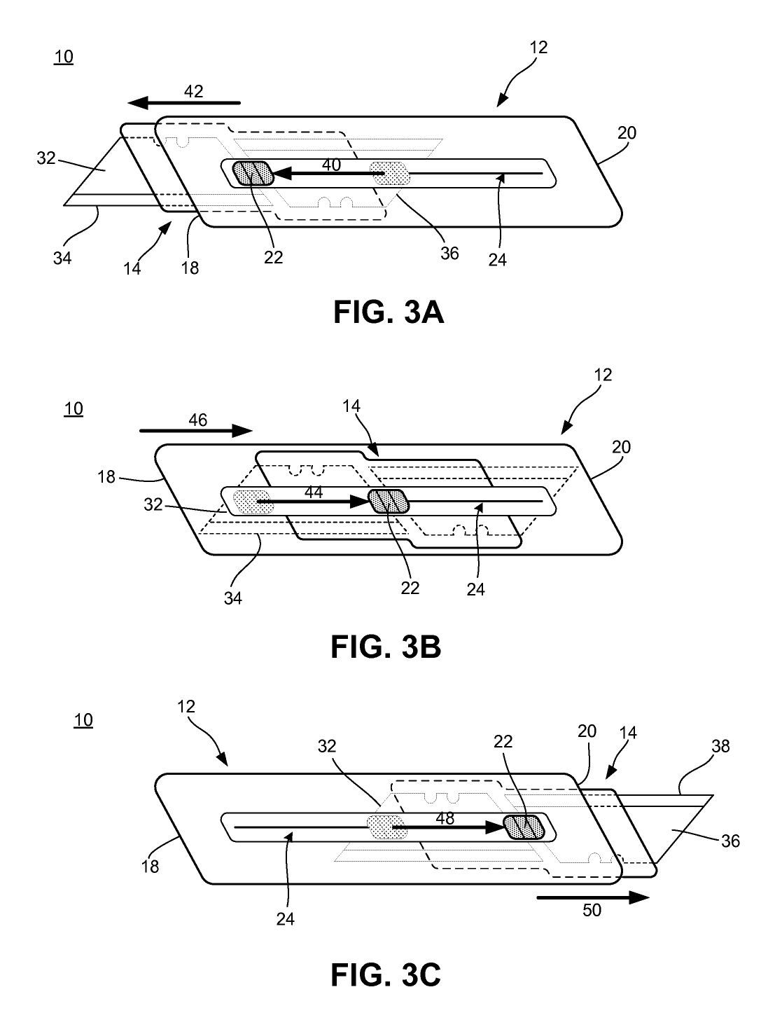

FIGS. 3A-3C are side views of the knife 10 of FIG. 2 showing the blade carrier 14 and, in turn, the first and second blades 32, 36 moving between retracted and extended positions. Referring to FIG. 3A, the first blade 32 is illustrated moving from a retracted position, as shown in FIG. 2, to an extended position wherein the edge 34 of the first blade 32 is exposed. As generally understood, the first end 18 of the body 16 of the housing 12 may include a slot (not shown) configured to allow the first cutting blade 32 and at least a portion of the first end 28 of the blade carrier 14 to move from within the interior of the housing 12 to the exterior. More specifically, the button 22 may allow a user to apply a force thereto and move (e.g. slide) the button 22 in a direction towards the first end 18 and away from the second end 20 of housing 12, as indicated by arrow 40. In turn, movement of the button 22 may cause the blade carrier 14 and the first blade 32 coupled thereto to move in a direction towards the first end 18 and away from the second end 20 of the housing 12, as indicated by arrow 42, thereby exposing the edge 34 of the first blade 32 (e.g., from a retracted position to an extended position). As shown, the second blade 36 is still retained within the housing 12, thus only a portion of the first blade 32 is exposed.

Referring to FIG. 3B, the first blade 32 is illustrated moving from the extended position of FIG. 3A back to a retracted position. As may be appreciated, a user may move the first blade 32 from the extended position to the retracted position by moving the button 22 generally in a direction towards the second end 20 of the housing 12, as indicated by arrow 44. In turn, movement of the button 22 may cause the blade carrier 14 and the first blade 32 coupled thereto to move in a direction towards the second end 20 and away from the first end 18 of the housing 12, as indicated by arrow 46, thereby covering the edge 34 of the first blade 32 and returning the button to the retracted position (e.g. neither blade 32, 36 is exposed).

Referring to FIG. 3C, the second blade 36 is illustrated moving from a retracted position, as shown in FIG. 3B, to an extended position wherein the edge 38 of the second blade 36 is exposed. As generally understood, the second end 20 of the body 16 of the housing 12 may include a slot (not shown) configured to allow the second cutting blade 36 and at least a portion of the second end 30 of the blade carrier 14 to move from within the interior of the housing 12 to the exterior. More specifically, the button 22 may allow a user to apply a force thereto and move (e.g. slide) the button 22 in a direction towards the second end 20 and away from the first end 18 of housing 12, as indicated by arrow 48. In turn, movement of the button 22 may cause the blade carrier 14 and the second blade 36 coupled thereto to move in a direction towards the second end 20 and away from the first end 18 of the housing 12, as indicated by arrow 50, thereby exposing the edge 38 of the second blade 36 (e.g., from a retracted position to an extended position). As shown, the first blade 32 is still retained within the housing 12 when the second blade 36 is in an extended position.

As may be appreciated, the knife 10 may be configured to house a reserve of extra blades for storage. Additionally, as generally understood, the knife 10 may include any known mechanism for relatively quick and simple blade exchange. For example, in one embodiment, the knife 10 may include a feeding structure or device for easily pushing or feeding or changing a spare blade from a reserve of blades stored internally within the knife 10 into the blade carrier without the need to open the housing 12. In another embodiment, the knife 10 may include a mechanism for releasably coupling the first and second blades 32, 36 to the carrier 14 and allowing a user to release the blades 32, 36 in exchange for another.

According to one aspect of the disclosure, there is provided a utility knife including a housing having a first end and a second end; and a blade carrier disposed at least partially within the housing. The blade carrier is configured to receive a first blade in a first end of the blade carrier and a second blade in a second end of the blade carrier, and is movable within the housing between a first extended position, a retracted position, and a second extended position. When the blade carrier is in the first extended position, the first blade is extended outwardly from the first end of the housing, when the blade carrier is in the retracted position the first and second blades are disposed entirely within the housing, and when the blade carrier is in the second extended position, the second blade is extended outwardly from the second end of the housing.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A utility knife comprising:
a housing having a first end and a second end; and
a blade carrier disposed at least partially within the housing, the blade carrier being configured to receive a first blade in a first end of the blade carrier and a second blade in a second end of the blade carrier, the blade carrier being movable within the housing between a first extended position, a retracted position, and a second extended position,
wherein when the blade carrier is in the first extended position, the first blade is extended outwardly from the first end of the housing, when the blade carrier is in the retracted position the first and second blades are disposed entirely within the housing, and when the blade carrier is in the second extended position, the second blade is extended outwardly from the second end of the housing.

2. The utility knife of claim 1, wherein the utility knife further comprises an actuator element coupled to the blade carrier for moving the blade carrier between the first extended position, the retracted position, and the second extended position.

3. A blade carrier for a utility knife, the blade carrier comprising:
a body configured to be received within a housing of the utility knife and having a first end and a second end;
the body being configured to receive a first blade in the first end and a second blade in a second end.
